(19) United States
(12) Patent Application Publication
(10) Pub. No.: US 2008/0038525 A1
(43) Pub. Date: Feb. 14, 2008

(54) Light refractive and diffusive optical element

(75) Inventors: Yun-Pin Yang, Taoyuan (TW); Chi-Wen Liao, Taoyuan (TW); Chi-Liang Tseng, Taoyuan (TW)

Correspondence Address: TROXELL LAW OFFICE PLLC, 5205 LEESBURG PIKE, SUITE 1404, FALLS CHURCH, VA, 22041, US

(73) Assignee: Exploit Technology Co., Ltd.

(21) Appl. No.: 11/502,508

(22) Filed: Aug. 11, 2006

(51) Int. Cl. B32B 5/16; B32B 9/04

(52) U.S. Cl. 428/212; 428/411.1; 428/323

(57) ABSTRACT

A light refractive and diffusive optical element includes a light-transmittable substrate, one or more relative refractive and diffusive layers provided on one surface of the substrate, and an antistatic adherent layer provided on an opposite surface of the substrate. Each of the relative refractive and diffusive layers includes more than one species of substance having a different refraction index each, so that the resultant relative refractive and diffusive layers have a relative refraction coefficient within a predetermined range. When there are multiple relative refractive and diffusive layers, the refraction coefficients of these layers may be in a predetermined ratio.

### FIELD OF THE INVENTION

The present invention relates to an optical element, and more particularly to a light refractive and diffusive optical element.

### BACKGROUND OF THE INVENTION

One of the conventional light diffusing elements includes a transparent substrate having a coarsened upper surface. Light is diffused when it passes through the coarsened upper surface of the light diffusing element.

Another conventional light diffusing element includes a transparent substrate having a diffuser applied on an upper surface thereof. The diffuser includes a plurality of diffusive particles and an adhesive material. The diffusive particles are either embedded in or protruded from the adhesive material. No matter the diffusive particles are embedded in or protruded from the adhesive material, they cause the diffuser to have a surface with coarseness. Light is diffused when it is projected through the coarse diffuser. The diffusive particles are naturally formed transparent balls. According to the principles of lens, such transparent balls may also diffuse light behind the focus.

From the above-mentioned light diffusing elements of prior art, it is known the diffusive element is characterized in the formation of a fine-grained coarse surface and adopts the principles of lens, so as to provide the function of diffusing uniform light. Some optical plastic materials, such as polystyrene, polymethyl methacrylate, and polycarbonate, have an optical refraction index of about 1.45˜1.62. High-refractivity particulate filler has been applied in filling the above-mentioned optical plastic materials. With the high-refractivity particles dispersed in the optical plastic material, the optical plastic material may have an increased refraction index, and can therefore be used to manufacture an antireflection article that is of zero reflection at a specific wavelength. U.S. Pat. No. 6,497,957 entitled “Antireflection Article of Manufacture” discloses the adding of nano-particles into optical plastic materials to improve antireflection articles.

### SUMMARY OF THE INVENTION

A primary object of the present invention is to provide a light refractive and diffusive optical element, which has a diffusive layer containing arbitrarily shaped particles to increase changes of refraction of light that passes the diffusive layer, so that the light is more uniformly diffused.

Another object of the present invention is to provide a light refractive and diffusive optical element, which includes more than one diffusive layer to enhance the brightness of light passing through the diffusive layers, so as to achieve the effect of brightness gain.

To achieve the above and other objects, the light refractive and diffusive optical element according to the present invention includes a light-transmittable substrate, one or more relative refractive and diffusive layers provided on one surface of the substrate, and an antistatic adherent layer provided on an opposite surface of the substrate. Each of the relative refractive and diffusive layers may consist of more than one species of substance having a different refraction index each, so that the resultant relative refractive and diffusive layer has a refraction index within a predetermined range. When there are multiple relative refractive and diffusive layers, it is possible for the relative refraction indexes thereof to be in a desired ratio. Whereby, when the light passes through materials having different refraction coefficients, the refraction angle varies with the materials being passed through. As a result, the light may be diffused through the multiple refraction angles under control.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a conceptual sectional view of a light refractive and diffusive optical element according to a first embodiment of the present invention;

FIG. 2 is an enlarged view of the area indicated by phantom line 2 in FIG. 1;

FIG. 3 is a conceptual sectional view of a light refractive and diffusive optical element according to a second embodiment of the present invention;

FIG. 4 is an enlarged view of the area indicated by phantom line 4 in FIG. 3; and

FIG. 5 is an enlarged view of the area indicated by phantom line 5 in FIG. 3.

### DETAILED DESCRIPTION OF THE PREFERRED EMBODIMENTS

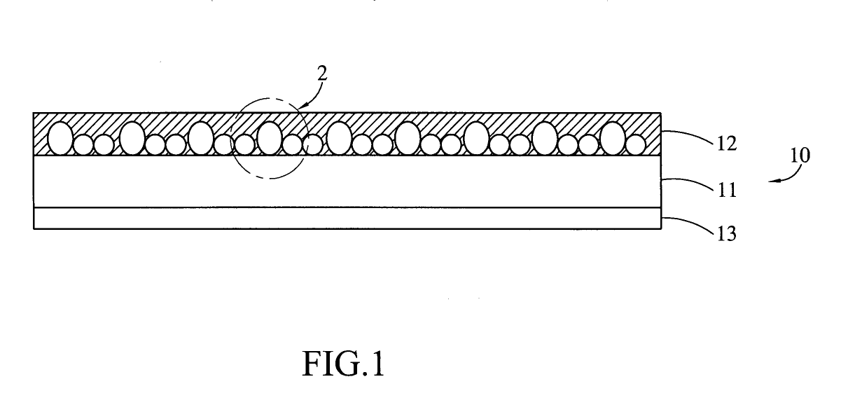

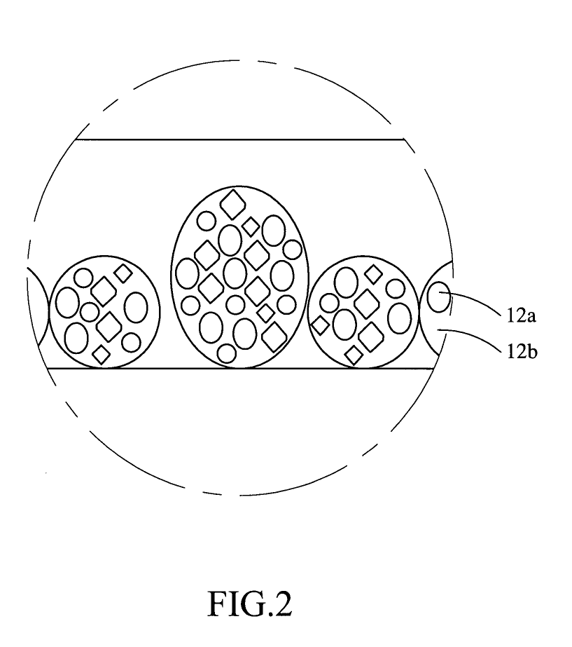

Please refer to FIGS. 1 and 2 that are conceptual sectional views of a light refractive and diffusive optical element 1 according to a first embodiment of the present invention. As shown, the light refractive and diffusive optical element 10 includes a light-transmittable substrate 11, a relative refractive and diffusive layer 12 provided on one surface of the substrate 11, and an antistatic adherent layer 13 provided on an opposite surface of the substrate 11.

The relative refractive and diffusive layer 12 includes more than one species of particles 12a with each species having a refraction index different from other species, and an optical material 12b mixed with the particles 12a. The particles 12a may be of any shape, and have an average diameter from 200 μm to 20 nm. Preferably, the particles 12a are evenly distributed in the relative refractive and diffusive layer 12, so that the resultant relative refractive and diffusive layer 12 at least has a relative refraction coefficient within the range from 0.2 to 4.5.

The substrate 11 may be an optical plastic material, such as polystyrene, polymethyl methacrylate, polycarbonate, polyvinyl, polypropylene, polyvinyl chloride, epoxy resin, and polyethylene terephthalate. Preferably, the substrate 11 has coarsened surfaces to produce a predetermined coarseness, so as to provide an enhanced diffusion effect.

The particles 12a may be light-transmittable organic synthetic resins or other materials, such as metal, air, compounds, etc. The optical material 12b may be light-transmittable organic synthetic resins, such as thermoplastic optical plastics or ultraviolet (UV) cured photo-curable plastics.

A total relative refraction coefficient between the optical material 12b and the particles 12a may be derived from the following formula:

$$\frac{\vert ( {n}_{1} - n ) \vert + … + \vert ( {n}_{i} - n ) \vert}{i} = {N}_{r}$$

where,

n₁˜nᵢ are absolute refraction indexes of different species of particles 12a;

n is an absolute refraction index of the optical material 12b;

Nᵣ is a relative refraction coefficient; and

i is the number of species of particles 12a having different refraction indexes.

Since the particles 12a have refraction indexes larger or smaller than the refraction index of the optical material 12b, and in accordance with the principles of refraction and diffusion, light refraction occurs when the light enters an optical medium, no matter what the density of the optical medium is, it is proper to use absolute values in practical calculation of the relative refraction index.

The weight of a specific species of particles 12a mixed with the optical material 12b at a predetermined percentage may be calculated using the following formula:

$$\frac{( {m}_{i} \times {d}_{i} )}{( {m}_{1} \times {d}_{1} ) + … + ( {m}_{i} \times {d}_{i} )} = Wi$$

where,

Wᵢ is the weight of the species of particles being calculated;

dᵢ is the density of the species of particles being calculated; and

mᵢ is the percentage by volume of the species of particles being calculated.

As to the percentage by volume of the particles 12a in the optical material 12b is preferably within the range from 15% to 85%.

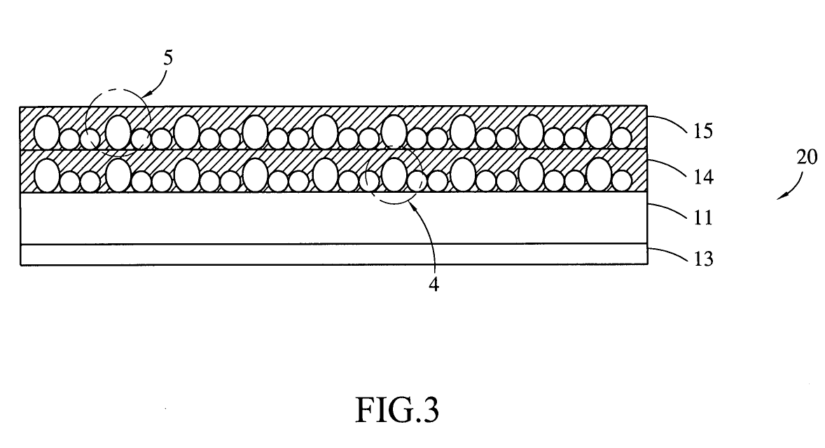

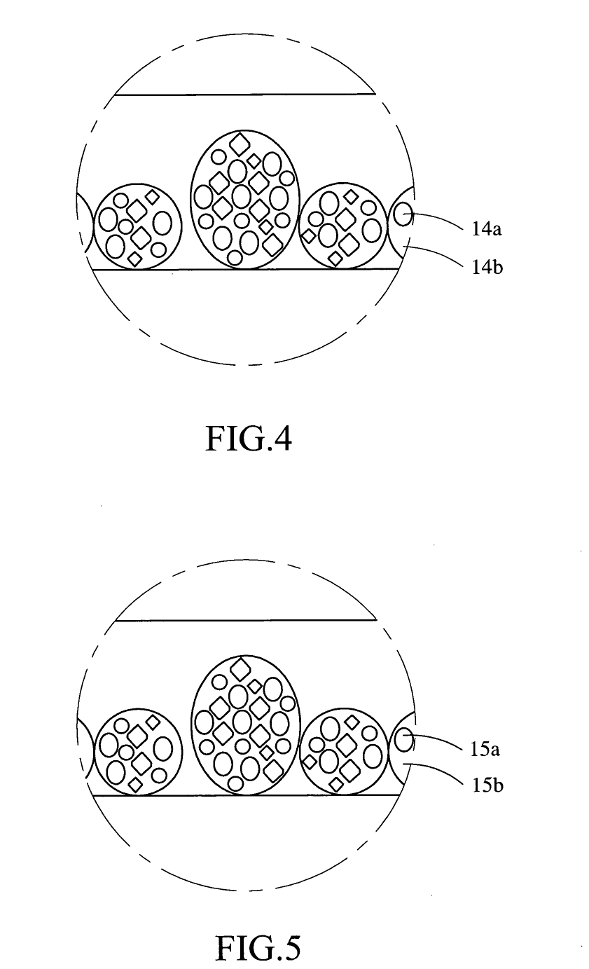

Please refer to FIGS. 3, 4, and 5 that are conceptual sectional views of a light refractive and diffusive optical element 20 according to a second embodiment of the present invention. As shown, the light refractive and diffusive optical element 2 includes a light-transmittable substrate 11, a plurality of relative refractive and diffusive layers 14, 15 sequentially provided on one surface of the substrate 11, and an antistatic adherent layer 13 provided on an opposite surface of the substrate 11.

The first relative refractive and diffusive layer 14 includes more than one species of particles 14a with each species having a refraction index different from other species, and an optical material 14b mixed with the particles 14a. The particles 14a may be of any shape, and have an average diameter from 200 μm to 20 nm, so that the resultant relative refractive and diffusive layer 14 has a relative refraction coefficient within the range from 0.2 to 4.5. The second relative refractive and diffusive layer 15 includes more than one species of particles 15a with each species having a refraction index different from other species, and an optical material 15b mixed with the particles 15a. The particles 15a may be of any shape, and have an average diameter from 200 μm to 20 nm, so that the resultant relative refractive and diffusive layer 15 has a relative refraction coefficient within the range from 0.2 to 4.5. It is understood, in the present invention, additional relative refractive and diffusive layers may be further provided.

Since the optical materials 14b and 15b have different refraction coefficients, and the particles 14a and 15a may also have different refraction coefficients, the optical element in the second embodiment of the present invention having two relative refractive and diffusive layers 14, 15 may replace two separate diffusers to advantageously reduce the material cost.

What is claimed is:

1. A light refractive and diffusive optical element, comprising:
a relative refractive and diffusive layer consisting of more than one species of particles with each species having a refraction index different from other species, and an optical material mixed with said particles;
an antistatic adherent layer; and
a substrate having two opposite surfaces, on which said relative refractive and diffusive layer and said antistatic adherent layer are separately provided.

2. The light refractive and diffusive optical element as claimed in claim 1, wherein said substrate is light transmittable.

3. The light refractive and diffusive optical element as claimed in claim 1, wherein said substrate is selected from the group consisting of polystyrene, polymethyl methacrylate, polycarbonate, polyvinyl, polypropylene, polyvinyl chloride, epoxy resin, and polyethylene terephthalate.

4. The light refractive and diffusive optical element as claimed in claim 1, wherein said substrate has coarsened surfaces to produce a predetermined coarseness.

5. The light refractive and diffusive optical element as claimed in claim 1, wherein said particles may be of any shape.

6. The light refractive and diffusive optical element as claimed in claim 1, wherein said particles have an average diameter within the range from 200 μm to 20 nm.

7. The light refractive and diffusive optical element as claimed in claim 1, wherein said relative refractive and diffusive layer has a relative refraction coefficient within the range from 0.2 to 4.5.

8. The light refractive and diffusive optical element as claimed in claim 1, wherein said particles are selected from the group consisting of light-transmittable organic synthetic resins, metal, air, and compounds.

9. The light refractive and diffusive optical element as claimed in claim 1, wherein said optical material is a light-transmittable organic synthetic resin.

10. The light refractive and diffusive optical element as claimed in claim 9, wherein said synthetic resin is selected from the group consisting of thermoplastic optical plastics and UV cured photo-curable plastics.

11. The light refractive and diffusive optical element as claimed in claim 1, wherein a total relative refraction coefficient of said optical material and said particles is:
$$\frac{\vert ( {n}_{1} - n ) \vert + … + \vert ( {n}_{i} - n ) \vert}{i} = {N}_{r}$$
where,
n₁˜nᵢ are absolute refraction indexes of different species of particles;
n is an absolute refraction index of the optical material;
Nᵣ is a relative refraction coefficient; and
i is the number of species of particles 12a having different refraction indexes.

12. The light refractive and diffusive optical element as claimed in claim 1, wherein said particles have refraction indexes larger than that of said optical material.

13. The light refractive and diffusive optical element as claimed in claim 1, wherein said particles have refraction indexes smaller than that of said optical material.

14. The light refractive and diffusive optical element as claimed in claim 1, wherein a weight of a specific species of said particles mixed with said optical material at a predetermined percentage is calculated as below:
$$\frac{( {m}_{i} \times {d}_{i} )}{( {m}_{1} \times {d}_{1} ) + … + ( {m}_{i} \times {d}_{i} )} = Wi$$
where,
Wᵢ is the weight of the species of particles being calculated;
dᵢ is the density of the species of particles being calculated; and
mᵢ is the percentage by volume of the species of particles being calculated.

15. The light refractive and diffusive optical element as claimed in claim 14, wherein said percentage by volume of said particles in said optical material is preferably within the range from 15% to 85%.

16. A light refractive and diffusive optical element, comprising:
a plurality of relative refractive and diffusive layers, each of which including more than one species of particles, with each species of said particles having a refraction index different from other species, and an optical material mixed with said species of particles;
an antistatic adherent layer; and
a substrate having two opposite surfaces, on which said relative refractive and diffusive layers and said antistatic adherent layer are separately provided.

17. The light refractive and diffusive optical element as claimed in claim 16, wherein said optical materials in different layers of said relative refractive and diffusive layers have different refraction coefficients, and said different species of particles have different refraction coefficients.
